(19) United States
(12) Patent Application Publication
(10) Pub. No.: US 2003/0110040 A1
(43) Pub. Date: Jun. 12, 2003

(54) System and method for dynamically changing software programs by voice commands

(75) Inventors: Michael A. Holland, McKinney, TX (US); Jimmy D. Prather, Sherman, TX (US); Rickey L. Rabon, Nevada, TX (US); Anthony W. Tillman, Denison, TX (US)

Correspondence Address: Michael L. Diaz, Michael L. Diaz, P.C., Suite 200, 555 Republic Drive, Plano, TX, 75074, US

(73) Assignee: CREATIVE LOGIC SOLUTIONS INC.

(21) Appl. No.: 10/012,604

(22) Filed: Dec. 7, 2001

(51) Int. Cl. G10L 21/00; G10L 11/00

(52) U.S. Cl. 704/275

(57) ABSTRACT

A method and system for creating programming language code through voice commands. The system includes an external input device such as a microphone, a computer for receiving the voice commands and converting the voice commands into programming language code and a targeted terminal having a targeted program utilizing the same programming language. The computer includes a voice-to-programming language converter for converting a person's voice commands into programming language. The computer also includes a locator module for identifying the commanded location of any voice commands within the targeted program. The system may be utilized to create new programs or dynamically change existing programs through voice commands. In addition, the system enables all programming language symbology to be created from voice commands.

### BACKGROUND OF THE INVENTION

1. Technical Field of the Invention

This invention relates to software programming and, more particularly, to a system and method for dynamically changing and creating software programs by utilizing voice commands.

2. Description of Related Art

The development of software has exponentially increased over the last decade. Computer software has been successfully used for the enhancement of people's life and the productivity of many individuals and businesses. However, software programming can be a very labor-intensive task for programmers. Adding to the difficulties in programming is that graphical symbology is often employed in developing various types of programs. For example, many programs employ a type of programming known as ladder logic. With ladder logic programming, a programmer utilizes various symbols which are non-textual in nature. Thus, the programmer must develop software using various symbols for developing the requested software. In addition, such symbols vary among assorted types of proprietary ladder logic programming systems, further increasing the difficulties for the programmer.

Voice recognition systems have been widely used over the past few years. The voice recognition systems allow the speech of an individual to be converted into text for use in a multitude of word processing programs. Although existing voice recognition systems provide an enhancement to word processing programs, there are no systems providing the conversion of voice patterns into non-textual programming symbols. In addition, no existing voice recognition system enables an operator to specify the location of the voice commands.

Software programmers also encounter other problems in modifying the programming of ongoing software programs. With such ongoing software programs, such as programmable logic controllers (PLCs), the programmer must modify the programs in a rapid manner to avoid the degradation of the software program. PLCs also may require the use of non-textual symbology, which further increases the difficulty of the programmer. A method and system are needed which allows a programmer to dynamically change a software program by utilizing a voice recognition system. The method and system must also be able to convert the voice patterns of the programmer into non-textual, as well as textual symbols in a specified programming language.

Although there are no known prior art teachings of a solution to the aforementioned deficiency and shortcoming such as that disclosed herein, prior art references that discuss subject matter that bears some relation to matters discussed herein are U.S. Pat. No. 4,747,127 to Hansen et al. (Hansen), U.S. Pat. No. 4,980,918 to Bahl (Bahl), U.S. Pat. No. 5,036,539 to Wrench, Jr. et al. (Wrench), U.S. Pat. No. 5,802,526 to Fawcett et al. (Fawcett), and U.S. Pat. No. 6,173,259 to Bijl et al. (Bijl).

Hansen discloses a telecommunication system for switching voice and data under computer control to a customer programmable environment that allows real-time modification of communication services. The computer program controlling the system is written in a nonprocedural language that allows for the direct control of the telecommunication system on the basis of the state definition, event definition, and action definition. Program scripts define a particular feature, and each script consists of a plurality of triples that automatically respond to the system state and signal information to execute the necessary actions to provide part of a feature to the telecommunication system. The system allows a customer to program his own individual communication unit to provide desired features without affecting the operation of the telecommunication system or the features provided to other customers. However, Hansen does not teach or suggest utilizing voice activation to convert voice commands into programming language.

Bahl discloses a continuous speech recognition system having a speech processor and a word recognition computer subsystem, characterized by an element for developing a graph for confluent links between confluent nodes, an element for developing a graph of boundary links between adjacent words, an element for storing an inventory of confluent links and boundary links as a coding invention. The patent also discloses a method for achieving continuous speech recognition by characterizing speech as a sequence of confluent links which are matched with candidate words. However, Bahl does not teach or suggest a system for converting voice commands into structured computer programming language.

Wrench discloses a real-time speech processing development system having a control subsystem (CS) and a recognition subsystem (RS) interconnected by a CS/RS interface. The CS includes a processor, an operator interface, a user interface, and a program module for loading any one of a plurality of control programs which may be employed in the speech recognition process. The RS includes a master processor, speech signal processor, and a template matching processor, all interconnected on a common bus which communicates with the CS via the CS/RS interface. However Wrench does not teach or suggest utilizing the speech processing system to convert voice commands to computer programming language. Wrench merely discloses an advanced speech-to-text conversion system.

Fawcett discloses a system utilizing an interactive voice response system (IVRS) and a graphical display of the IVRS menus. The graphical display allows a caller to navigate upon and down in the IVRS menus, skipping intermediate steps that would be required in making responses to voice queries. HTML is used to produce the graphical display. The HTML data also contains a predefined protocol used to display IVRS menus. Although Fawcett discloses a system utilizing a voice response system providing a graphical display of the menus for the user, Fawcett does not teach or suggest utilizing a voice activation system to convert voice commands to computer programming language. Fawcett merely uses graphical displays to provide menus to the users of a voice response system.

Bijl discloses a speech-to-text conversion system which includes a user terminal for recording speech, an automatic speech recognition processor to generate text from a recorded speech file, a communication system which includes a remote terminal and a server to provide the transfer of recorded speech files to a selected automatic speech recognition processor. However, Bijl does not teach or suggest utilizing the speech to text conversion system to convert voice commands to computer programming language.

Thus, it would be a distinct advantage to have a system and method which converts human speech into programmable language readable by a computer. The converted programmable language may be both textual and non-textual symbols. In addition, it would be advantageous to have a system and method which may be employed to dynamically change programmable language of an ongoing software program. It is an object of the present invention to provide such a system and method.

### SUMMARY OF THE INVENTION

In one aspect, the present invention is a system for creating programming language code from voice commands issued by an operator of the system. The system includes a computing system and an external input device for communicating voice commands issued from the operator to the computing system. The system also includes a targeted computer communicating with the computing system. The computing system converts voice commands issued from the operator to a programming language code readable by the targeted computer. The operator issues voice commands into the external input device which is sent to the computing system. The computing system then converts the voice commands into programming language code within the targeted computer.

In another embodiment of the present invention, the system is a system for creating programming language code from voice commands issued by an operator of the system. The system includes a computing system which converts voice commands issued from the operator into programming language code and a device for receiving voice commands from operator to the computing system. The operator issues voice commands which are converted into programming language code.

In still another aspect, the present invention is a method of converting voice commands issued from an operator to programming language code. The method starts by programming a computing system to associate at least one voice command with a designated programming language code. Next, the operator voices a command to the computing system. The voice command is recognized by the computing system and correlated with the designated programming language code. Next, the voice command is converted into the designated programming language code.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a voice activation programming system in the preferred embodiment of the present invention;

FIG. 2 is a program script illustrating a creation of a new programmable logic controller (PLC) according to the teachings of the present invention;

FIG. 3 is a program script illustrating the implementation of controller properties within a targeted program according to the teachings of the present invention;

FIGS. 4A and 4B are program scripts illustrating the implementation of an I/O configuration within a target program according to the teachings of the present invention;

FIGS. 5A-5C are program scripts illustrating the implementation of a channel configuration within a targeted program according to the teachings of the present invention;

FIG. 6 is a program script illustrating the creation of a program file according to the teachings of the present invention;

FIG. 7 is a program script illustrating the building of a rung of logic within a ladder of a program according to the teachings of the present invention; and

FIGS. 8A and 8B are flow charts outlining the steps for utilizing the system to create programming language code according to the teachings of the present invention.

### DETAILED DESCRIPTION OF EMBODIMENTS

The present invention is a system and method for dynamically programming software programs through voice commands.

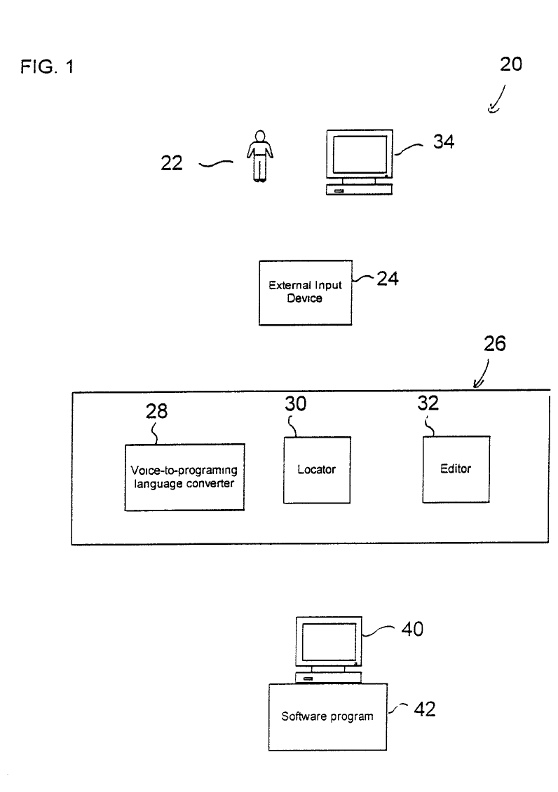

FIG. 1 is a simplified block diagram illustrating the components of a voice activation programming system 20 in the preferred embodiment of the present invention. The system includes an operator, 22 using a terminal 34, an external input device 24, and an integral computer 26. The computer 26 includes a voice-to-programming language converter 28, a locator 30, and an editor 32. In addition, the system includes a computer 40 utilizing a software program 42.

The computer 26 converts voice commands issued by the operator 22 into an appropriate programming language used in the software program 42 operated by the computer 40. The issued voice commands are automatically converted into the appropriate programming command. Additionally, the system 20 can dynamically edit existing programs through voice commands issued by the operator.

The external input device 24 receives the sound waves produced by the operator 22 and converts the sound waves into electrical signals. The electrical signals are then sent to the computer 26. The external input device is preferably a microphone common in voice recording. However, any device capable of converting sound into electrical signals may be utilized. The external input device may be physically connected to the computer 26, such as through a wire connection, or sent via any form of radio communications. In an alternate embodiment of the present invention, the external input device records the sounds produced by the operator and stores the sounds. The sounds are then sent, either physically (e.g., the operator inputs the stored voice commands into a disk which is directly read by the computer 26), or through a communication link with the computing system.

The computer 26 may receive voice commands from the external input device 24. The computer may also convert the voice commands into a programming language appropriate for the targeted software program 42 through the voice-to-programming language converter 28. The converter recognizes each command and converts electrical signals associated with the voice commands into signals associated with the programming language. The converter is programmed to understand specific commands and correlate the voice commands with specific programming language inputs. Conversion of voice to text is commonly used in word processing programs. The converter takes the voice to text conversion one step farther by enabling the creation of specific programming language code. The converter may utilize a lookup table having voice commands correlated to specific programming instructions. The voice commands do not have to specifically state each programming language input. The voice commands may include code words associated with specific actions implemented within the programming language. Unlike existing voice to text converters, the converter 28 may convert the receive voice commands into programming language which includes other symbols in addition or in place of text. The resultant programming language may be any language utilized by a computer, such as “C,” Basic, Pascal, Fortran, etc., to include all ASCH characters on an individual level in any language.

The computer 26 also utilizes the locator 30 to locate the commanded positions within the software program 42 for implementation of the converted programming language commands in its proper place within the program. Specifically, the operator may command that a specific command be positioned at a commanded location within the software program. The locator enables the computer 26 to find the commanded location. The locator may be used to create new programs which require placement or editing, or for use with currently operating or created software programs. Thus, the system 20 may be used to dynamically change a currently operating software program currently.

The computer 26 also employs the editor 32 to revise current programming steps by locating the targeted steps via the locator, and through the issued commands of the operator (converted from the converter 28), changes the targeted steps appropriately.

The operation of the system 20 will now be explained. The operator speaks into the external input device 24 voicing specific commands for the creation or editing of the program 42. The program 42 utilizes a specific programming language. The voice commands received by the external input device are sent as electrical signals to the computer 26. The computer 26 sends the received voice commands to the voice-to-programming language converter. The converter is initially programmed to recognize voice commands and correlate the voice commands with specific programming language steps in the desired programming language. The voice commands may be abbreviated or code words used to trigger specific programming steps. The converter also communicates with the locator 30 to provide location commands sent from the operator 22. The locator receives the specific locations for implementation of the programming step within the targeted program (either existing or currently developed). The locator finds the specific locations within the program. The editor is used to command the implementation of the programming step at the specific location within the program. The transcribed programming step is then sent to the computer 40 for implementation within the software program 42. The computer 26 may communicate with the computer 40 in any fashion allowing the transmission of the programming steps into the program 42.

The creation of new programs is possible through the Implementation of system 20. The operator 22 may operate with any programming language utilized by the targeted software program 42. For example, if Basic programming language is used, the operator may issue the first line command through a voice command. The operator may utilize voice commands to continue building the program using predefined commands or ASCH characters on each line of code written. In the preferred embodiment of the present invention, after each line of the programming language of the program is transcribed, the operator may enter an ENTER command, signifying acceptance of the transcribed line of code and prompting for input of the next line of code.

Following through with the above example of a Basic program, additional lines of code may be added to an existing program. Specifically, the operator verbally or manually inputs the specified command and identifies the location of where each commanded line should be inputted. For example, the operator may insert a line of code by executing an “Insert” command. The operator then would issue the commands for insertion (e.g., “IF xxxxxxxxxx; THEN xxxxxxxxxx”).

Additionally, the system 20 may utilize the editor 32 to interpret all written software (e.g., PLC, MI, or Graphics software) currently utilized in the existing program. Interpretation of the current lines of code is necessary for inputting specific instructions such as timers, counters, bit address, or any other structured instructions currently used or envisioned in the future.

For example, the operator 22 may need to build a new ladder file. Implementation of a newly created ladder file may be accomplished by the operator verbally issuing a proper sequence of instructions, such as a name of a file, a number or a name of a ladder file to commence the building of the program. Once the targeted ladder file has been designated by the locator 30, the operator may be informed of the location and voice commands specifying the location of the instructions as well as the rung number location.

The operator 22 may also provide additional lines of programming to an existing program. For example, the operator may add a timer to a specific rung within a ladder logic used within the program. The operator identifies the specific rung of logic to be changed through voice command via the external input device 24. The operator may then execute an edit command through the targeted computer 40. Next, the operator may define the position of the instruction/step to be added. The operator may then voice an execute for an add command for the timer with the address which defines and associates values necessary for the timer operation. Next, the operator then issues a command to assemble all edits, test the edits and runs the changes executed to the program file. Additionally, the operator may define specific steps to be modified or removed in the same manner as described above for adding steps to an existing program.

The operator 22 may also develop a new human machine interface (HMI) file by voicing a series of properly sequenced plurality of instructions, such as a name of a file, a topic, an application source access, a first window and a screen name. Once the MMI preliminary instructions have been designated through voice command from the operator, the operator then starts executing the name of the devices to be used and specifying the location of those device though voice activation using X and Y coordinates, based on the pixel size of the operator's terminal 34. Typically, the operator will utilize both the external input device 24 in conjunction with the terminal 34 to develop or modify several types of programs. Any text addition of the window or screen may then be implemented through the external input device by voicing the X and Y coordinates. For example, to position a START BUTTON at coordinates 150 and 600, the operator voices the command, “START BUTTON 150-600”. A graphical interface or device is then placed on the window or screen at the designated location. After the operator determines the location of the device, the operator then identifies the attributes of the device by issuing an “ATTRIBUTES” command. The operator, through voice command via the external input device, then specifies the desired attributes of the device.

Any additions, modifications, or deletions of an existing MMI development package may also be accomplished in a similar manner by identifying the window or screen that the changes are to be made, executing the proper identification of the device or text to be added. Additionally, the X and Y coordinate location and associated attributes are identified by the operator.

The system 20 may be used to develop new graphics system programming. For example, the operator 22 may build a new graphics package by issuing a plurality of properly sequenced instructions, such as a name of a file, a first window and a screen name. Once the operator has issued the plurality of sequenced instructions through voice command, the operator may then executing the name of the devices to be used and designating the location of those devices through voice command denoting the X and Y coordinates, based on pixel size of the terminal 34. For example, to place a targeted line of instructions at coordinates 150 and 600, the operator issues a voice command via the external input device 24 stating “TARGET X 150-600.” The target may then be positioned on the window or screen at the commanded location. After the operator identifies the location of the device, the operator then may identify the attributes of the device by issuing a voice command (“ATTRIBUTES”). Next, the operator verbally identifies the attributes.

In addition, any modifications to existing graphics programs may also be accomplished by identifying the location, the specific instructions to be added, modified or deleted and verbally commanded to be inserted within the existing program. The modifications may be accomplished in the same manner as described above for creating the graphics system programming.

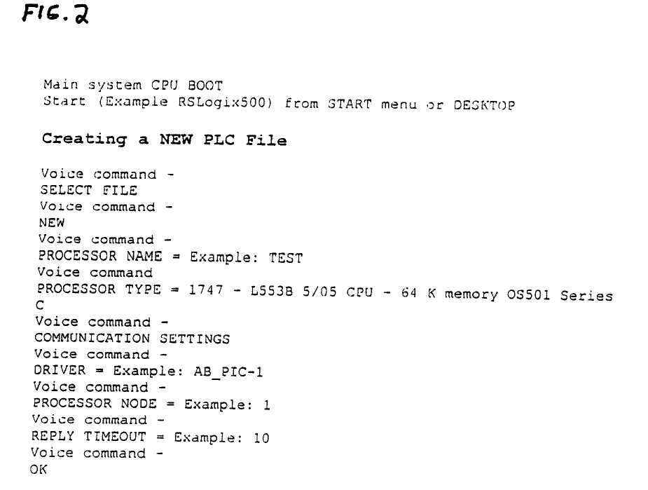

FIG. 2 is a program script illustrating a creation of a new programmable logic controller (PLC) according to the teachings of the present invention. The illustrated program script is a sample program exemplifying the operator 22's voice commands to create the new PLC file.

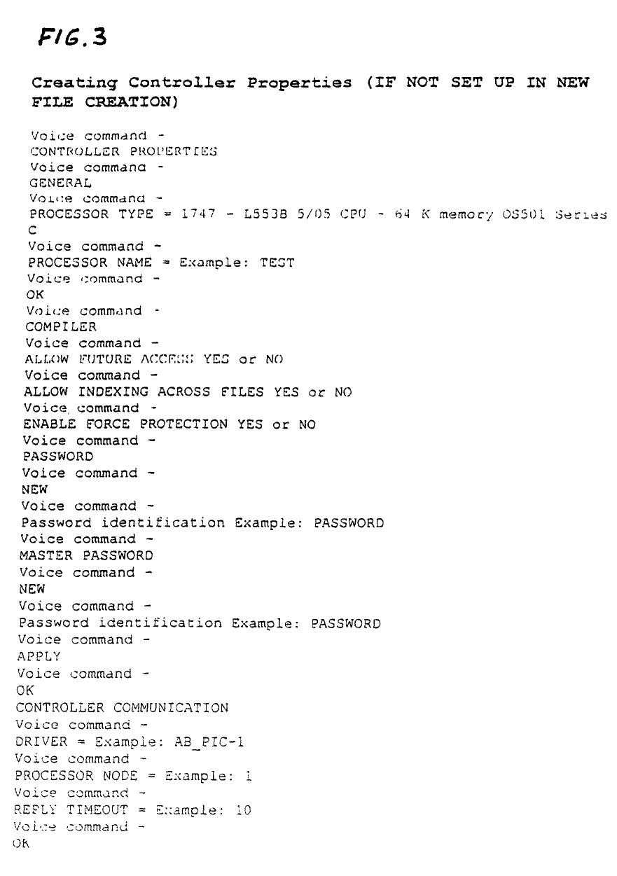

FIG. 3 is a program script illustrating the implementation of controller properties within a targeted program according to the teachings of the present invention. As illustrated, the operator voices the command “CONTROLLER PROPERTIES” to prompt implementation of controller properties.

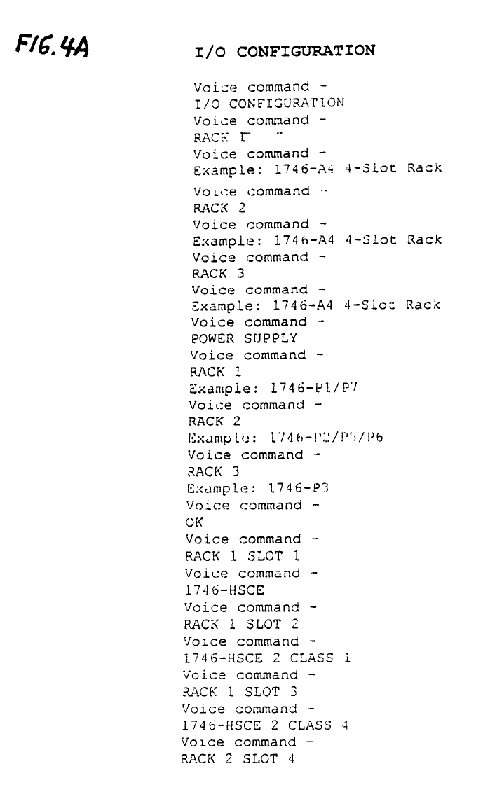

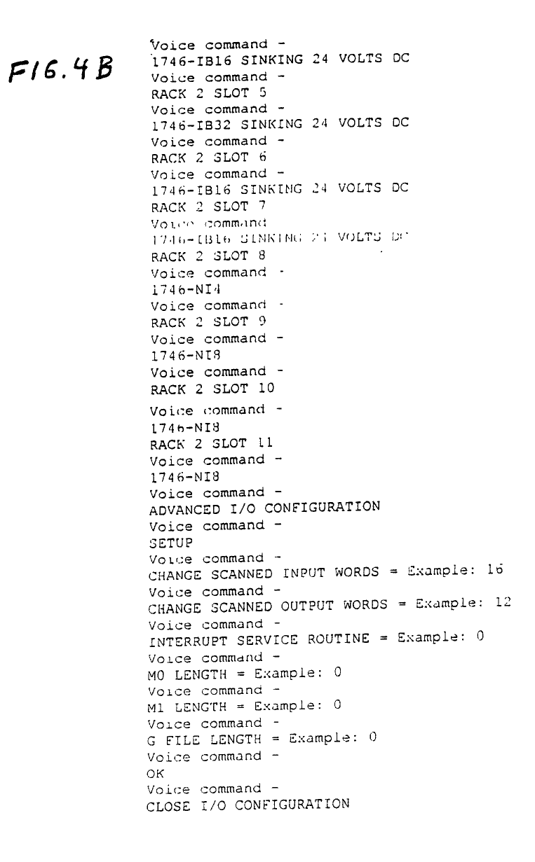

FIGS. 4A and 4B are program scripts illustrating the implementation of an I/O configuration within a target program according to the teachings of the present invention. The operator 22 may specifically implement an I/O configuration within a target program by voicing an “I/O CONFIGURATION” command and identifying the desired location.

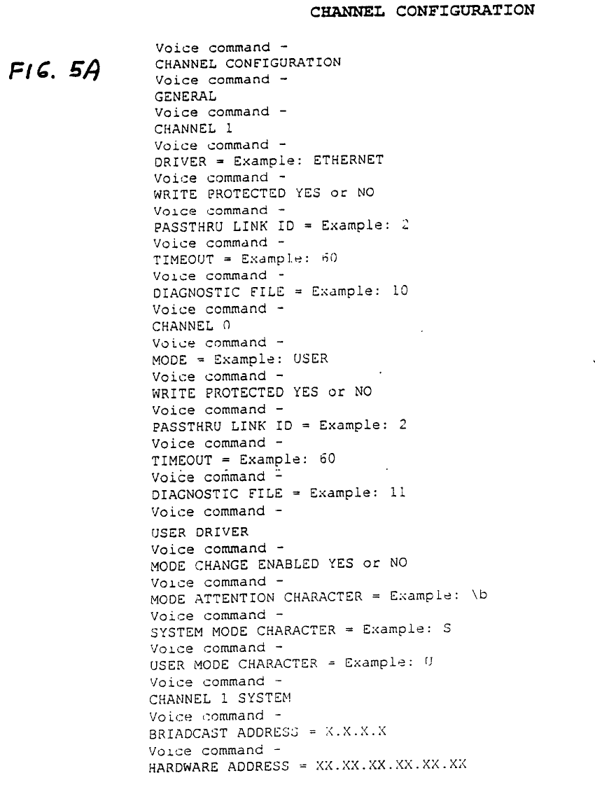

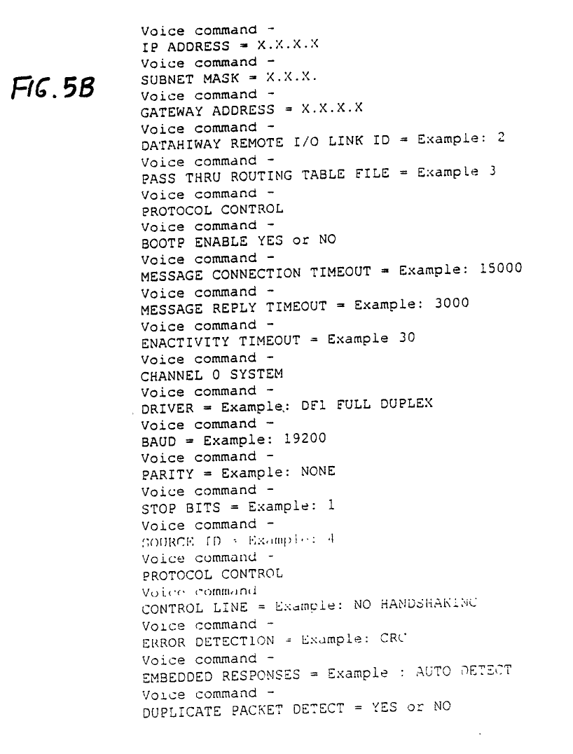

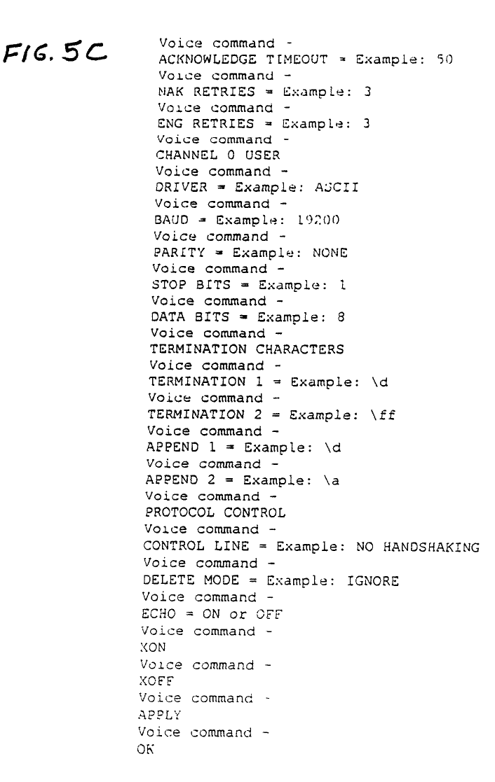

FIGS. 5A-5C are program scripts illustrating the implementation of a channel configuration within a targeted program according to the teachings of the present invention. FIGS. 5A-5C exemplify the script which may be used by the operator 22 to designate a channel configuration within the targeted program.

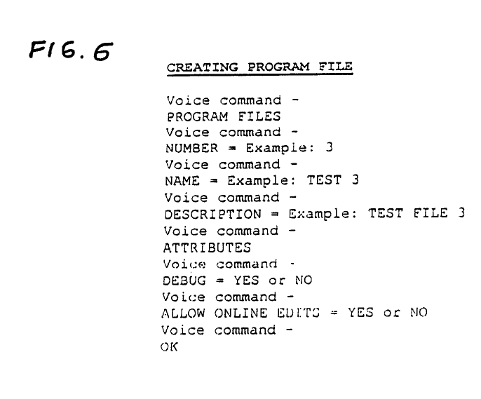

FIG. 6 is a program script illustrating the creation of a program file according to the teachings of the present invention. The operator may command “PROGRAM FILES” to prompt the creating of a program file for a software program.

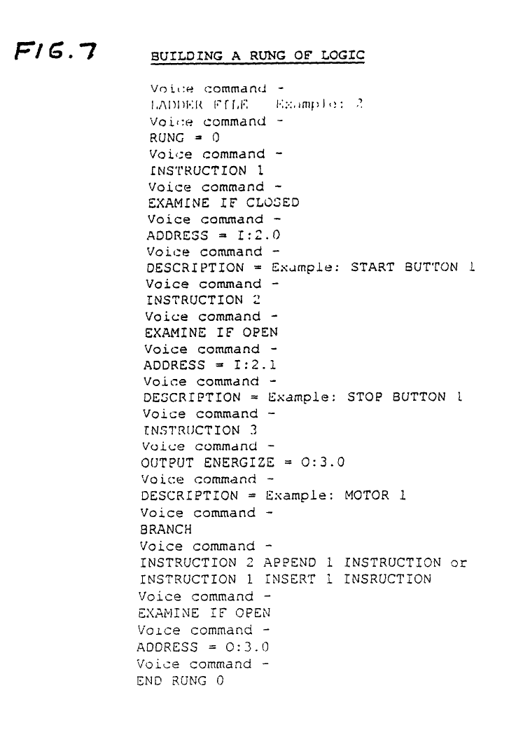

FIG. 7 is a program script illustrating the building of a rung of logic within a ladder of a program according to the teachings of the present invention. FIG. 7 is an example of the operator's voice commands to build a rung of logic.

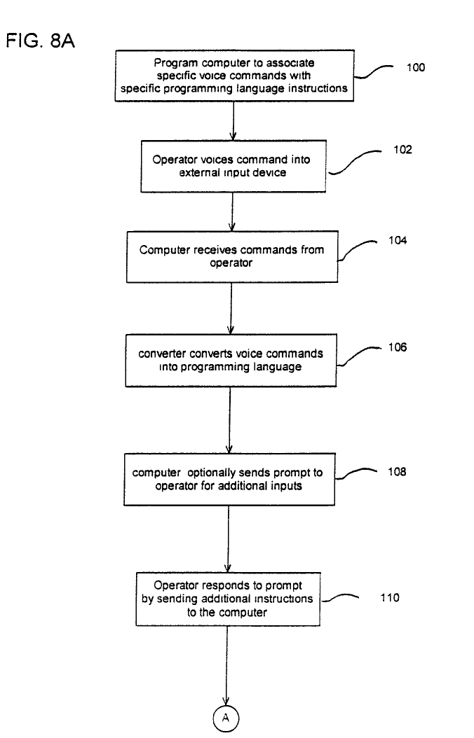

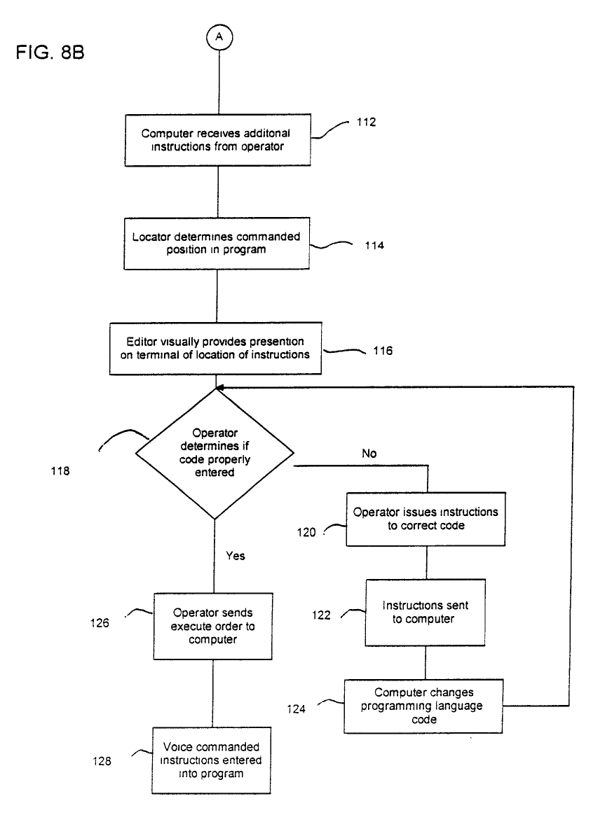

FIGS. 8A and 8B are flow charts outlining the steps for utilizing the system 20 to create programming language code according to the teachings of the present invention. With reference to FIGS. 1, 8A, and 8B, the steps of the method will now be explained. The method begins with step 100 where the computer 26 is programmed to recognize specific voice commands and associate the commands with specific programming language code. The voice commands may be code words or literal transcriptions of the voice commands. In addition, the computer may be programmed for responding with prompts either through visual signals sent to the terminal 34 or aural signals asking for further information. For example, if a specific command is issued by the operator, the computer may responds to the specific command with a query for further information necessary to execute the code, such as the location of where the command is to be implemented. The prompt may optionally be sent to the operator. In an alternate embodiment of the present invention, the computer is triggered to receive specific verbal/terminal input from the operator 22. In such a configuration, the computer may be keyed to receive the location or some additional instructions after receipt of the initial verbal command.

Next, in step 102, the operator voices a command into the external input device 24. Optionally, the operator may also input specific data via conventional means into the terminal 34 (e.g., via keyboard and mouse). The method continues from step 102 to step 104 where the computer 26 receives the commands from the operator. In step 106, the voice-to-programming language converter 28 converts the verbal command into programming language code. The converter must recognize the voice command, correlate the received voice command to a specific programming language code and then convert the voice command to the designated programming language code. Next, in step 108, if the computer determines that additional verbal/manual commands are necessary to implement the voice command, may optionally send a prompt to the operator. The prompt may be issued through the terminal 34.

In step 110, the operator 22 answers the prompt or independently enters any additional commands necessary to implement the desired initial command. For example, the operator may provide the specific location of the position for entering the line of instruction in the program. Alternatively, the operator may enter all information during the initial voice command in step 102. Next, in step 112, the computer receives the additional requested data from the operator. The converter converts any verbal commands requiring conversion into programming language code. The programming language may be in any language and may include non-textual symbology associated with programming language code.

The method moves to step 114, where the locator determines the commanded position within the targeted program 42. In step 116, the computer, through the editor, provides a visual indicator to the terminal 34 to indicate the placement of the commanded code. Additionally, the editor may optionally and conditionally position the commanded code into the proper position and illustrate the code (e.g., in highlighted form) to the operator via the terminal. In step 118, the operator determines if the operator's commands have been properly coded and positioned within the program.

If the operator determines that the operator's commands have not been entered properly, the method moves to step 120 where the operator issues corrections to the conditional programming language code. Next, in step 122, any modification commands issued by the operator are sent via the external input device 24 to the computer 26. In step 124, the converter changes the modification commands into programming language code in the identified position within the program 42. The method then returns to step 118.

However, if the operator determines that the operator's commands have been properly entered, the method moves from step 118 to step 126 where the operator sends an execute command to the computer 26. Next, in step 128, the voice implemented line of instruction is created in the designated location within the program 42.

The system 20 and its associated method described in FIG. 8 allows the creation of new programs utilizing any programming language code. The programming language may be any language and include various symbols not typically associated with text. The converter is used to recognize voice commands and correlate the voice commands to specific programming language codes. In addition, the operator may simultaneously use other means for communicating the operator's intent to the computer 26. For example, a terminal may be used in conjunction with the external input device 24 to create or modify existing programming language code. The terminal may be used to offer a visual presentation of the verbally commanded code to insure that it has been properly converted from voice command to programming language code.

In addition, the system 20 and its method also provides a novel system for dynamically changing existing and/or programs through verbal commands. The use of voice commands is particularly useful for an operator/programmer modifying programs efficiently, quickly, and accurately.

The present invention provides many advantages over existing systems. Existing systems provide a voice-to-text conversion which can be used in word processing computer programs. However, these existing systems do not enable a programmer to write programming language code for a computer software program. The disclosed invention provides a system and method for quickly and efficiently implementing programming language code to create a new program. In addition, the present invention enables a programmer to effectively and quickly modify existing programs.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for creating programming language code from voice commands issued by an operator of said system, said system comprising:
a computing system;
an external input device for communicating voice commands issued from the operator to said computing system;
a targeted computer communicating with said computing system; and
said computing system having means for converting voice commands issued from the operator to a programming language code readable by said targeted computer;
whereby said operator issues voice commands into said external input device, said external input device sending the voice commands to the computing system for conversion into programming language code, said computing system assembling the programming language code within said targeted computer.

2. The system of claim 1 wherein said computing system assembles voice commands to create a program within said targeted computer.

3. The system of claim 1 wherein said targeted computer includes a plurality of lines of programming code and said computing system includes a locator for locating a position for placement of a converted programming language code within the plurality of lines of programming code.

4. The system of claim 1 wherein said means for converting voice commands issued from the operator to a programming language code includes a lookup table correlating a plurality of voice commands with a plurality of specific programming language codes, whereby a specific voice command is matched with a designated programming code.

5. The system of claim 1 wherein said means for converting voice commands issued from the operator to a programming language code includes means for converting voice commands into non-textual symbols.

6. The system of claim 1 wherein said targeted computer includes an existing targeted program using the programming language code, whereby said computing system dynamically modifies the existing targeted program through voice commands issued from the operator.

7. The system of claim 6 wherein said computing system includes means for identifying specific locations for a programming language code issued by voice command from the operator.

8. The system of claim 1 wherein said computing system includes means for prompting the operator for additional data necessary to implement the voice commands into a program stored within said targeted computer.

9. The system of claim 1 wherein said computing system includes means for editing a converted programming language code by the operator.

10. The system of claim 1 wherein said computing system resides within the targeted computer.

11. A system for creating programming language code from voice commands issued by an operator of said system, said system comprising:
a computing system having means for converting voice commands issued from the operator into programming language code; and
means for receiving voice commands from operator to said computing system;
whereby said operator issues voice commands which are converted into programming language code.

12. A method of converting voice commands issued from an operator to programming language code, said method comprising the steps of:
programming a computing system to associate at least one voice command with a designated programming language code;
voicing a command by the operator to the computing system;
recognizing the voice command issued by the operator;
correlating the voice command with the designated programming language code; and
converting the voice command into the designated programming language code.

13. The method of converting voice commands of claim 12 further comprising, after the step of converting the voice command into the designated programming language code, the step of sending the converted programming language code to a targeted computer storing a program utilizing the programming language code.

14. The method of converting voice commands of claim 13 wherein the targeted computer includes a stored, existing computer program utilizing the programming language code.

15. The method of converting voice commands of claim 12 further comprising, after the step of recognizing the voice command issued by the operator, the step of prompting the operator for additional data necessary to implement the designated programming language code.

16. The method of converting voice commands of claim 12 further comprising, after the step of converting the voice command into the designated programming language code, the step of querying the operator to determine if the designated programming language code has been properly converted.

17. The method of converting voice commands of claim 16 further comprising, after the step of querying the operator, the steps of:
voicing a second command to modify the designated programming language code;
recognizing the second voice command issued by the operator;
correlating the second voice command with the modified, designated programming language code; and
converting the voice command into the modified, designated programming language code.

18. The method of converting voice commands of claim 12 further comprising, after the step of converting the voice command into the designated programming language code, the step of locating a proper position to place the programming language code within a plurality of programming language codes.

19. The method of converting voice commands of claim 12 wherein the step of programming a computing system to associate at least one voice command with a designated programming language code includes programing the computing system to associate a plurality of voice commands with a plurality of designated program language codes, each voice command matching a specific programming language code.

20. The method of converting voice commands of claim 12 wherein the step of converting the voice command into the designated programming language code includes converting the voice command into programming language code having non-textual symbols.
